(19) United States
(12) Patent Application Publication
(10) Pub. No.: US 2006/0222908 A1
(43) Pub. Date: Oct. 5, 2006

(54) Perpendicular magnetic disk apparatus

(75) Inventors: Takeshi Abe, Ome-shi (JP); Yuka Aoyagi, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/394,239

(22) Filed: Mar. 31, 2006

(30) Foreign Application Priority Data
Mar. 31, 2005 (JP) 2005-100295

(51) Int. Cl. G11B 5/66

(52) U.S. Cl. 428/848.2; 428/828.1

(57) ABSTRACT

According to one embodiment, there is provided a perpendicular magnetic disk apparatus including a perpendicular magnetic recording medium including a nonmagnetic substrate having a surface roughness (Ra) of 0.35 nm or less, a soft underlayer, a nonmagnetic intermediate layer having a perpendicular orientation (Δθ₅₀) of 4° or less, and a perpendicular recording layer made of a magnetic material having perpendicular anisotropy, and a magnetic head including a write head and a magnetoresistive read head, the write head having a main pole, a return yoke, and an exciting coil, wherein a flying height (f) of the magnetic head and an average surface roughness (Ra) of the perpendicular magnetic recording medium satisfy the following relationship: f>0.61Ra²−3.7Ra+5.9.

### CROSS-REFERENCE TO RELATED APPLICATIONS

This application is based upon and claims the benefit of priority from Japanese Patent Application No. 2005-100295, filed Mar. 31, 2005, the entire contents of which are incorporated herein by reference.

### BACKGROUND

1. Field

One embodiment of the present invention relates to a magnetic disk apparatus adopting a perpendicular magnetic recording system.

2. Description of the Related Art

Recently, downsizing and increase in density of recording media have been advanced in the field of hard disk drives used for various purposes. However, the longitudinal recording system that is widely adopted at present has a problem that the probability of magnetization reversal due to thermal fluctuation increases as the recording density is made high. Therefore, the longitudinal recording system has come to its limit in compatibility between maintained recording stability and increase in density.

To solve the above problem, a perpendicular magnetic recording system has been developed for practical application. In the perpendicular magnetic recording system, magnetizations adjacent to one another with magnetization transition interposed therebetween are coupled in an antiparallel alignment. By this structure, recording media adopting the perpendicular magnetic recording system have a property that demagnetizing fields decrease as the recording density becomes high, and thus can maintain a more stable recording state against thermal fluctuation.

A magnetic disk apparatus adopting the perpendicular magnetic recording system comprises a perpendicular magnetic recording medium, and a magnetic head including a write head and a magnetoresistive read head. The write head includes a main pole, an exciting coil, and a return yoke. The perpendicular magnetic recording medium has a structure that a soft underlayer, a nonmagnetic intermediate layer, and a perpendicular recording layer formed of magnetic material having perpendicular anisotropy are stacked on a nonmagnetic substrate.

In the perpendicular magnetic recording medium, a read output voltage depends on perpendicular orientation of the perpendicular recording layer. Poor perpendicular orientation of the perpendicular recording layer extends an initial layer (a region where crystals are not perpendicularly oriented), and hinders reduction in medium noise. Since the perpendicular recording layer is formed on the stack of the nonmagnetic substrate, the soft underlayer, and the nonmagnetic intermediate layer, improvement in surface smoothness of each layer is required to enhance the perpendicular orientation of the perpendicular recording layer.

In prior art, there has been proposed a perpendicular magnetic recording medium wherein a smoothness control film is provided between the substrate and the soft underlayer to improve surface smoothness of the soft underlayer, the nonmagnetic intermediate layer, and the perpendicular recording layer which are stacked thereon. Thereby, medium noise is reduced, and signal-to-noise ratio (SNR) is improved (see Jpn. Pat. Appln. KOKAI Pub. No. 11-203653).

Further, there has been proposed a magnetic disk apparatus which is aimed at improving flying performance of the head and SNR by using a disk substrate having a surface roughness of 0.3 nm or less (see Jpn. Pat. Appln. KOKAI Pub. No. 2004-280961).

However, the present inventors have found that smoothing the surface of the perpendicular magnetic recording medium improves flying stability of the medium, but also intensifies a problem of sticking of the head to the medium under reduced pressures.

The prior art, however, does not consider the problem of sticking of the medium to the disk under reduced pressures. Further, adding a smoothness control film as in Jpn. Pat. Appln. KOKAI Pub. No. 11-203653 increases manufacturing steps and cost.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic cross-sectional view of a perpendicular magnetic disk apparatus according to an embodiment of the present invention;

FIG. 2 is a graph illustrating relationship between substrate surface roughness Ra and perpendicular orientation Δθ₅₀ of a nonmagnetic intermediate layer;

FIG. 3 is a graph illustrating relationship between attained linear recording density (kBPI) and Δθ₅₀ of the nonmagnetic intermediate layer;

FIG. 4 is a graph illustrating relationship between the substrate surface roughness Ra, touchdown pressure and takeoff pressure; and

FIG. 5 is a graph illustrating relationship between the substrate surface roughness Ra and flying height of a head that achieves the takeoff property of 0.6 atmospheric pressure that is a guarantee of operation for the magnetic disk apparatus.

### DETAILED DESCRIPTION

Various embodiments according to the invention will be described hereinafter with reference to the accompanying drawings. In general, according to one embodiment of the present invention, there is provided a magnetic disk apparatus comprising: a perpendicular magnetic recording medium including a nonmagnetic substrate having a surface roughness (Ra) of 0.35 nm or less, a soft underlayer, a nonmagnetic intermediate layer having a perpendicular orientation (Δθ₅₀) of 4° or less, and a perpendicular recording layer made of a magnetic material having perpendicular anisotropy; and a magnetic head including a write head and a magnetoresistive read head, the write head having a main pole, a return yoke, and an exciting coil, wherein a flying height (f) of the magnetic head and an average surface roughness (Ra) of the perpendicular magnetic recording medium satisfy the following relationship:
f>0.61Ra²−3.7Ra+5.9.

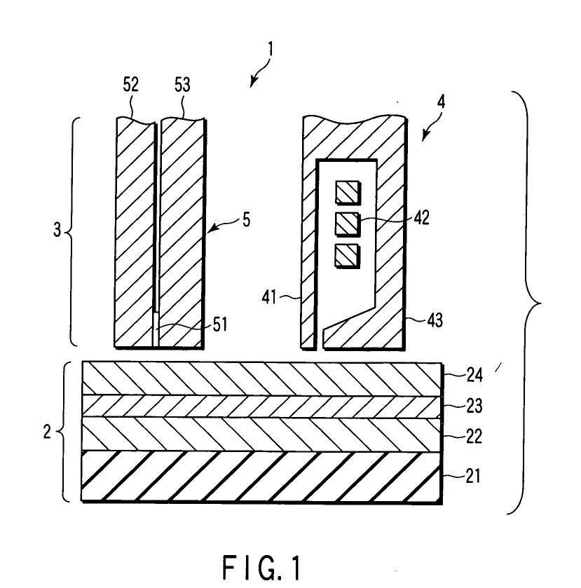

FIG. 1 illustrates a structure of a magnetic disk apparatus 1 according to an embodiment of the present invention. The magnetic disk apparatus 1 comprises a perpendicular recording medium 2 and a magnetic head 3. The perpendicular recording medium 2 of FIG. 1 has a structure that a nonmagnetic substrate 21, a soft underlayer 22, a nonmagnetic intermediate layer 23, and a perpendicular recording layer 24 made of a magnetic material having perpendicular anisotropy are successively stacked in this order from the bottom. The magnetic head 3 has a write head 4 and a magnetoresistive read head 5. The write head 4 includes a main pole 41, an exciting coil 42, and a return yoke 43. The magnetoresistive read head 5 includes a magnetoresistive film 51 and shields 52 and 53 sandwiching the magnetoresistive film 51.

As the nonmagnetic substrate 21, used is an Si single-crystal substrate, a glass substrate, or an Al substrate appropriate polished by any method. The nonmagnetic substrate 21 has a surface roughness (Ra) of 0.35 nm or less.

As the soft underlayer 22, a soft magnetic material having high magnetic permeability is used. Examples of the soft magnetic material are CoZrNb, FeTaC, FeZrN, FeSi alloy, FeAl alloy, FeNi alloy such as Permally, FeCo-based alloy such as Permendur, FeCoNi alloy such as Perminvar, NiCo alloy, FeAlSi alloy such as Sendust, MnZr-based ferrite, MgMn-based ferrite, MgZn-based ferrite, FeAlGa, FeCuNbSiB, FeGeSi, FeSiC, FeZrB, FeZrBCu, CoFeSiB, CoTi, and CoZrTa. The thickness of the soft underlayer 22 is 10 nm or more, preferably 20 nm to 200 nm. The soft underlayer 22 may have a structure of including magnetically-coupled two or more soft magnetic layers, which are stacked with a nonmagnetic layer such as Ru interposed therebetween.

As the perpendicular recording layer 24, used is: CoCrPt alloy, CoCr alloy, CoPt alloy, CoPtB, or CoPtCrB; a multilayer film obtained by alternately stacking Co layers and layers of at least one selected from the group consisting of Pt, Pd, Rh and Ru; or a multilayer film such as CoCr/PtCr, CoB/PdB, and CoO/RhO, obtained by adding Cr, B or O to each layer of the above multilayer film.

In the magnetic disk apparatus according to the embodiment of the present invention, the surface roughness (Ra) of the perpendicular magnetic recording medium 2 and the flying height (f) of the magnetic head 3 satisfy the following relationship;
f>0.61Ra²−3.7Ra+5.9.

Next, explained is the reason for specifying the surface roughness Ra of the nonmagnetic substrate 21.

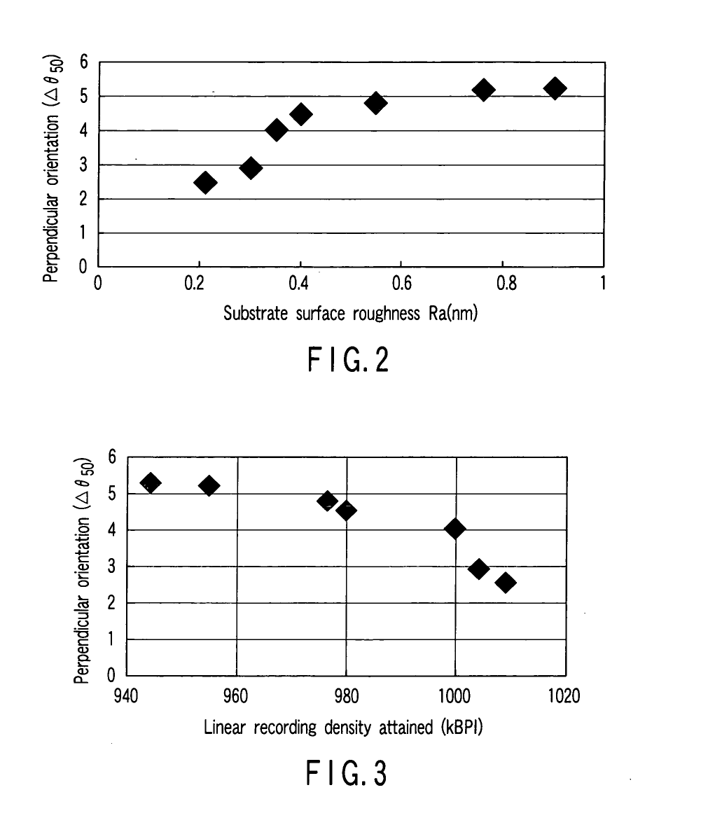

The perpendicular orientation of the perpendicular recording layer greatly depends on the perpendicular orientation of the nonmagnetic intermediate layer directly under the perpendicular recording layer. Therefore, by determining the perpendicular orientation of the nonmagnetic intermediate layer, the perpendicular orientation of the perpendicular recording layer was checked. A soft underlayer, a nonmagnetic intermediate layer, and a perpendicular recording layer were deposited by sputtering on each of nonmagnetic substrates which are different in surface roughness (Ra), and thereby media were prepared. These media were subjected to X-ray diffraction to determine Δθ₅₀ that is a full width at half maximum of a rocking curve of an hcp (0002) peak. FIG. 2 illustrates relationship between Ra of the nonmagnetic substrate and Δθ₅₀ of the nonmagnetic intermediate layer. By reducing the surface roughness Ra of the nonmagnetic substrate from 0.9 nm to 0.21 nm, the full width at half maximum Δθ₅₀ of a rocking curve of the hcp (0002) peak was reduced from 5.3 degrees to 2.5 degrees, and the perpendicular orientation thereof was improved.

Further, the media were subjected to write and read experiments. Measurement of the media was performed with a head having a magnetic write track width (MWW) of about 0.2 μm, a magnetic read track width (MRW) of about 0.1 μm, and read gap length of about 0.06 μm. The qualities of read signals were evaluated with bit error rate (BER). For example, if an on-track BER was 10⁻⁴ or less at a certain recording density, it was regarded as achieving the recording density. FIG. 3 illustrates relationship between Δθ₅₀ of the nonmagnetic intermediate layer and an attained recording density in kBPI (kilo bit per inch) obtained from measurement results of the read property. The attained recording density is improved, as the value of Δθ₅₀ of the nonmagnetic intermediate layer is reduced and the perpendicular orientation is improved. Specifically, the SNR is improved as the perpendicular orientation of the perpendicular recording film is improved. In order to enhance the areal recording density, there are two approaches to enhance the track per inch (TPI) and the bit per inch (BPI). A narrow recording track width weakens the magnetic field intensity generated from the tip end of the head, and makes it difficult to improve the SNR. Therefore, to enhance the areal recording density, it is preferable to enhance the linear recording density by improving the medium. To achieve an areal recording density of 150 Gbit per square inch, supposing that it is required to design the densities of 1000 kBPI×150 kTPI, Δθ₅₀ for achieving 1000 kBPI is 4° or less, and the surface roughness Ra of the nonmagnetic substrate in this case is 0.35 nm or less.

Next, explained is the reason for specifying relationship between the surface roughness Ra of the perpendicular magnetic recording medium 2 and the flying height of the magnetic head 3.

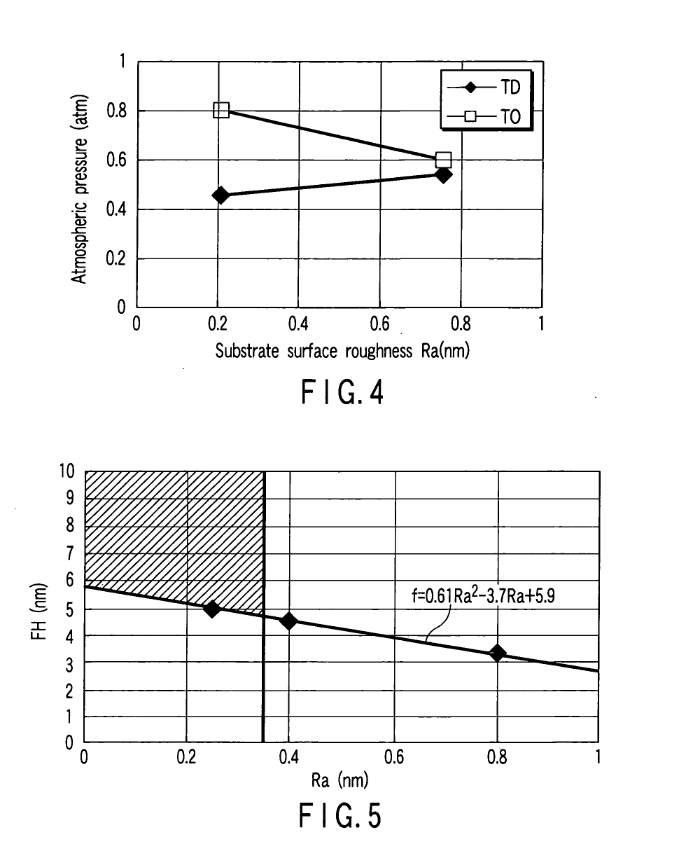

An atmospheric pressure at which the head contacts the medium is called touchdown pressure (TD), and an atmospheric pressure at which the head takes off again after making a touchdown once is called takeoff pressure (TO). FIG. 4 illustrates test results under reduced pressures in the case where the flying height of the perpendicular magnetic head is 3.3 nm. Supposing that the flying height is 3.3 nm and the atmospheric pressure which satisfies the TO property is 0.6 atmospheric pressure that is an operation guarantee value of the magnetic disk apparatus, a required surface roughness Ra of the nonmagnetic substrate 21 is 0.8 nm. Suppose that the surface roughness Ra of the nonmagnetic substrate is equal to the surface roughness Ra of the medium. FIG. 5 illustrates results of similar tests under reduced pressures using heads of various flying heights. According to FIG. 5, a good TO property is obtained at 0.6 atmospheric pressure if the flying height (f) of the head and the average surface roughness (Ra) of the medium satisfy the relationship:
f>0.61Ra²−3.7Ra+5.9.

As described above, according to the present invention, the surface roughness Ra of the substrate is limited to 0.35 nm or less, and thereby it is possible to set the perpendicular orientation of the perpendicular recording layer of the perpendicular magnetic recording medium (Δθ₅₀ of the nonmagnetic intermediate layer) to 4° or less, and thereby achieve a magnetic disk apparatus having a perpendicular magnetic recording medium with an areal recording density of 150 Gbit per square inch. Further, the flying height f of the head and the average surface roughness Ra of the medium are set to have the relationship “f>0.61Ra²−3.7Ra+5.9”, and thereby it is possible to obtain a sufficient TO property under reduced pressures.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic disk apparatus comprising:
a perpendicular magnetic recording medium including a nonmagnetic substrate having a surface roughness (Ra) of 0.35 nm or less, a soft underlayer, a nonmagnetic intermediate layer having a perpendicular orientation (Δθ₅₀) of 4° or less, and a perpendicular recording layer made of a magnetic material having perpendicular anisotropy; and
a magnetic head including a write head and a magnetoresistive read head, the write head having a main pole, a return yoke, and an exciting coil,
wherein a flying height (f) of the magnetic head and an average surface roughness (Ra) of the perpendicular magnetic recording medium satisfy the following relationship:
f>0.61Ra²−3.7Ra+5.9.

2. The perpendicular magnetic disk apparatus according to claim 1, wherein the nonmagnetic substrate is selected from the group consisting of an Si single-crystal substrate, a glass substrate, and an Al substrate.

3. The perpendicular magnetic disk apparatus according to claim 1, wherein the soft underlayer includes a soft magnetic material selected from the group consisting of CoZrNb, FeTaC, FeZrN, FeSi, FeAl, FeNi, FeCo, FeCoNi, NiCo, FeAlSi, MnZr-based ferrite, MgMn-based ferrite, MgZn-based ferrite, FeAlGa, FeCuNbSiB, FeGeSi, FeSiC, FeZrB, FeZeBCu, CoFeSiB, CoTi, and CoZrTa.

4. The perpendicular magnetic disk apparatus according to claim 1, wherein the soft underlayer has a thickness of 10 nm or more.

5. The perpendicular magnetic disk apparatus according to claim 4, wherein the soft underlayer has a thickness of 20 nm to 100 nm.

6. The perpendicular magnetic disk apparatus according to claim 3, wherein the soft underlayer includes at least two soft magnetic layers stacked with a nonmagnetic layer interposed therebetween.

7. The perpendicular magnetic disk apparatus according to claim 6, wherein the nonmagnetic layer included in the soft underlayer is an Ru layer.

8. The perpendicular magnetic disk apparatus according to claim 1, wherein the perpendicular magnetic recording layer is selected from the group consisting of CoCrPt, CoCr, CoPt, CoPtB, CoPtCrB, and a multilayer obtained by alternately stacking Co and one of Pt, Pd, Rh and Ru.

9. The perpendicular magnetic disk apparatus according to claim 8, wherein Cr, B or O is added to each layer of the multilayer film.
